(19) United States
(12) Patent Application Publication
(10) Pub. No.: US 2008/0051988 A1
(43) Pub. Date: Feb. 28, 2008

(54) In-vehicle controller

(75) Inventor: Masaya Segawa, Nara (JP)

Correspondence Address: RABIN & Berdo, PC, 1101 14TH STREET, NW, SUITE 500, WASHINGTON, DC, 20005, US

(73) Assignee: JTEKT Corporation, Osaka (JP)

(21) Appl. No.: 11/892,080

(22) Filed: Aug. 20, 2007

(30) Foreign Application Priority Data
Aug. 22, 2006 (JP) 2006-224998

(51) Int. Cl. G06F 17/40; G01C 21/00

(52) U.S. Cl. 701/207; 701/200

(57) ABSTRACT

An in-vehicle controller of the invention is a so-called drive recorder. The drive recorder is incorporated in a steering ECU (controller) 10. For this purpose, the controller 10 is provided with function implementation units which includes a memory 22 as a data logging section, a memory controlling section 23, a threshold judging section 24 and a data-transfer timing output section 25. Vehicle information and steering information are stored in a first memory 221 in chronological order. A second memory 222 logs data recorded in a tens-second period before and after a moment when vehicle acceleration exceeds a predetermined threshold. The information logged by the second memory 222 is transferred to a hard disk of a navigation unit 30 in a predetermined timing.

### BACKGROUND OF THE INVENTION

1. Field of the Invention

The present invention relates to an in-vehicle controller which utilizes an existing electronic control unit (ECU) in a vehicle, in particular a steering ECU or brake ECU, for implementing functions of a so-called drive recorder.

2. Description of Related Art

In order to deal with a motor vehicle accident and to reduce the number of motor vehicle accidents, the drive recorder has been developed with an aim at widespread use of the drive recorder in business-purpose vehicles such as taxies and trucking vehicles.

One example of the drive recorder is disclosed in Japanese Unexamined Patent Publication No. 2003-87778. The drive recorder of this patent publication is designed to record images of the interior of the vehicle and the scene around the vehicle, which are captured through a super-wide-angle lens set in the vehicle for a predetermined time period before an impact shock on the vehicle, or before/after the impact shock on the vehicle. The drive recorder has various functions useful for the analysis of the circumstances at the occurrence of the accident.

Although the drive recorders heretofore proposed in the art provide an effective tool to deal with a motor vehicle accident or to reduce the number of motor vehicle accidents, the following problem exists. The drive recorder is developed as a special-purpose device and is usually option for a vehicle. Hence, the drive recorder is costly.

More specifically, the drive recorder is constituted as a device which includes an image-pickup super-wide-angle lens, a CPU and various storage units and which is independent from normal on-board devices. Further, the drive recorder must be so designed and positioned as to ensure a recording operation and the like during a period before and after the occurrence of an accident if the vehicle should be involved in the accident. Naturally, the drive recorder is a costly device.

The expensive drive recorder is useless until the vehicle encounters an accident. Accordingly, the drive recorders have not yet to be popularized.

### SUMMARY OF THE INVENTION

In view of the foregoing, it is a primary object of the invention to provide an in-vehicle controller having a drive recorder functions, which is less costly and excellent in performance and can contribute to the increase of penetration rate of the drive recorder.

It is another object of the invention to provide an in-vehicle controller adapted to incorporate a drive recorder functions in the existing vehicle controller, such as a steering ECU.

It is still another object of the invention to provide an in-vehicle controller for use in a vehicle equipped with a navigation unit, which has a drive recorder functions.

According to the invention, vehicle information and steering information crucial for the drive recorder are first stored in a storage unit installed in the in-vehicle controller. Subsequently, the vehicle information and steering information stored in the storage unit are transferred to the navigation unit in a predetermined timing such as when the vehicle is stopped with the motor idling, or at predetermined time intervals. The navigation unit normally has a large memory such as a hard disk therein. Hence, these information items can be favorably stored in the navigation unit without encountering a problem that an available memory region is insufficient for the inputted vehicle information and steering information.

Since the navigation unit is often disposed at place easy for a user to manipulate, the user may easily retrieve the information from the navigation unit.

Accordingly, the invention can provide the in-vehicle controller which is less costly and features user-friendly drive recorder functions.

According to another aspect of the invention, information recorded at a crucial moment for the drive recorder can be efficiently stored at a second storage unit. The crucial information may be, for example, information recorded in a predetermined period before and after a moment when the behavior of the vehicle is significantly changed like when the acceleration of the vehicle exceeds a predetermined threshold. The information stored in the second storage unit is associated with the time point of the moment of exceeding the threshold, thus offering an advantage of easy linking to other information items as will be described hereinlater.

According to still another aspect of the invention, vehicle position information detected by the navigation unit can also be stored as associated with the vehicle information and steering information. This results in even further enhanced drive recorder functions.

The constitution of the invention may further comprise a camera unit for acquiring at least an image of outside circumstances of the vehicle, and an image data writing control unit for storing the image data in the storage unit or the navigation unit. This permits the image data to be associated with the vehicle position information and the steering information, and the image data recorded at the moment of interest to be stored. Thus, the drive recorder functions can be enhanced even further.

### BRIEF DESCRIPTION OF THE DRAWINGS

FIG. 1 is a conceptual diagram for illustrating an arrangement of an electric power steering apparatus equipped with a steering ECU, in which an in-vehicle controller according to an embodiment of the invention is implemented;

FIG. 2 is a block diagram for illustrating an electrical arrangement of a controller 10 and a connection relation of a navigation unit 30 and an additional unit 40 which are electrically connected to the controller 10;

FIG. 3 is a flow chart showing a control operation executed by the controller 10 and the contents of drive-recorder operations executed by a memory controlling section 23, a threshold judging section 24, a data-transfer timing output section 25 and a memory 22;

FIG. 4 is a flow chart showing the steps of a control operation executed by the navigation unit 30; and

FIG. 5 is a flow chart showing the steps of a control operation executed by the additional unit 40.

### DETAILED DESCRIPTION OF PREFERRED EMBODIMENTS

The preferred embodiments of the present invention will hereinbelow be described in details with reference to the accompanying drawings.

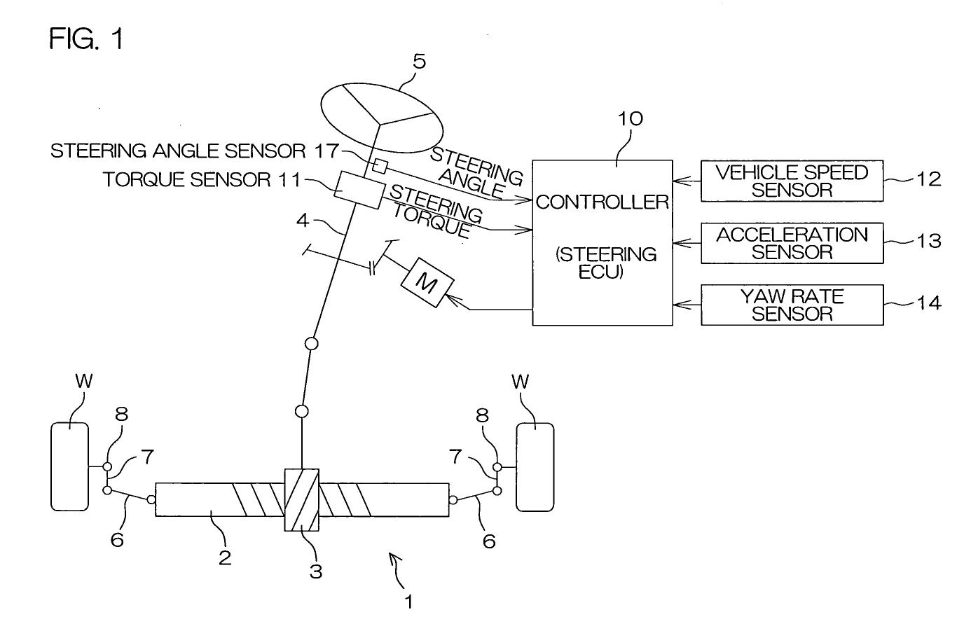

An in-vehicle controller according to an embodiment of the invention is implemented in a steering ECU (Electronic Control Unit). FIG. 1 is a conceptual diagram for illustrating an arrangement of an electric power steering apparatus including the steering ECU. The electric power steering apparatus is designed to transmit a torque generated by an electric motor M as a steering actuator to a steering mechanism 1 for steering steerable vehicle wheels W (such as front-right and front-left vehicle wheels) of a vehicle. The steering mechanism 1 is of a rack and pinion type which includes: a rack shaft 2 extending transversely in the vehicle; and a pinion 3 meshed with a rack of the rack shaft 2. The pinion 3 is coupled to one end of a steering shaft 4, the other end of which is coupled to a steering wheel 5. Therefore, when the steering wheel 5 is operatively rotated, the rotational motion of the steering wheel 5 is transmitted to the rack shaft 2 via the steering shaft 4 and the pinion 3, to be converted to axial movement of the rack shaft 2.

The opposite ends of the rack shaft 2 are connected with one ends of a pair of tie rods 6, respectively. The other ends of the pair of tie rods 6 are connected with one ends of a pair of knuckle arms 7, respectively. The pair of knuckle arms 7 are each pivotally supported about each of a pair of king pins 8 and are connected to the pair of steerable road wheels W respectively. According to this arrangement, the axial movement of the rack shaft 2 causes the knuckle arms 7 to pivot about the king pins 8, whereby the steerable road wheels W are steered.

A controller (also referred to as “steering ECU”) 10 for controlling the electric motor M is provided for the purpose of applying a proper steering force to the steering mechanism 1. The controller 10 is adapted to receive: an output signal from a torque sensor 11 for detecting a steering torque applied to the steering wheel 5; an output signal from a steering angle sensor 17 for detecting an steering angle of the steering wheel 5 by detecting a rotation angle of the steering shaft 4; an output signal from a vehicle speed sensor 12 for detecting a speed of the vehicle equipped with the electric power steering apparatus; an output signal from an acceleration sensor 13 for detecting an acceleration of the vehicle equipped with the electric power steering apparatus; and an output signal from a yaw rate sensor 14 for detecting a yaw rate of the vehicle equipped with the electric power steering apparatus. The controller 10 may also be adapted to receive an operation signal from a direction indicator associated with the steering wheel 5.

The controller 10 normally controls the electric motor M according to an assist mode. The assist mode means a control mode wherein the electric motor M is controlled based on the steering torque detected by the torque sensor 11 and the vehicle speed detected by the vehicle speed sensor 12 to generate a steering assist force for assisting a driver in steering operation.

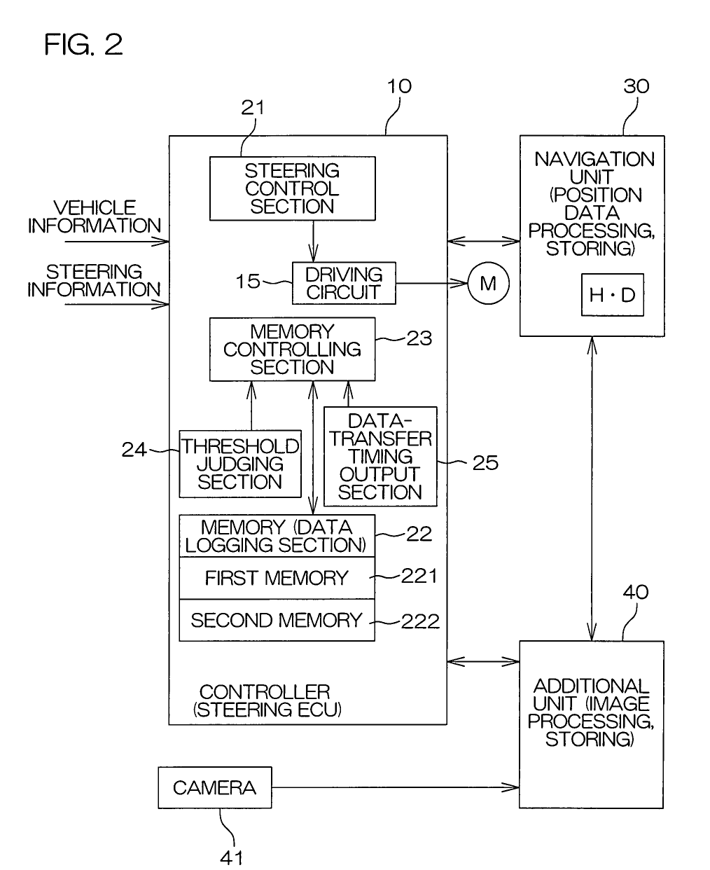

FIG. 2 is a block diagram for illustrating an electrical arrangement of the controller 10 and a connection relation of a navigation unit 30 and an additional unit 40 which are electrically connected to the controller 10. The controller 10 includes a microcomputer and memories as well as a driving circuit 15 for supplying an electric power from an on-board battery to the electric motor M.

A plurality of functional processing units implemented in predetermined programs executed by means of the microcomputer and memories of the controller 10 are represented by blocks, which include: a steering control section 21 for controlling the electric motor M according to the assist mode; a memory (data logging section) 22 for logging necessary data for operation as a drive recorder; a memory controlling section 23 for controlling the memory 22; a threshold judging section 24 and a data-transfer timing output section 25 for applying a trigger signal to the memory controlling section 23. The memory 22 is segmented into a first memory 221 for receiving information and a second memory 222 for storing information, which will be described hereinlater.

As described above, the detection signals from the vehicle speed sensor 12, acceleration sensor 13 and yaw rate sensor 14 are applied to the controller 10 as vehicle information. On the other hand, the steering angle detected by the steering angle sensor 17 and the steering torque detected by the torque sensor 11 are applied to the controller 10 as steering information. In the controller 10, the memory controlling section 23, threshold judging section 24, data-transfer timing output section 25 and memory 22 execute predetermined functions of the drive recorder based on these vehicle information items and steering information items.

The controller 10 is also electrically connected with the navigation unit 30 (navigation system) and the additional unit 40 which are set in the vehicle. The navigation unit 30 and the additional unit 40 are also electrically connected with each other. These connection relations may be established by an in-vehicle LAN (Local Area Network), for example.

The navigation unit 30 is installed in the vehicle. The navigation unit is operative to detect the present position of the vehicle based on signals and the like inputted thereto via a GPS (Global Positioning System) antenna and the like, and to display map information and the present position of the vehicle on a display screen. The navigation unit 30 normally includes a large memory device such as a hard disk.

The additional unit 40 is operative to process image data, for example, on scenes out the front of the vehicle captured by an in-vehicle camera 41 and to store the processed data as needed. The additional unit 40 and the in-vehicle camera 41 can be options for the vehicle. The additional unit 40 is electrically connected to the controller 10 and the navigation unit 30, so as to be capable of sending/receiving signals or information thereto/therefrom.

The feature of the embodiment resides in that the controller (steering ECU) 10 is imparted with basic functions of the drive recorder and that the controller 10 functioning as the drive recorder operates to transfer the logged data to the large memory of hard disk in the navigation unit 30 at a predetermined timing. Another feature of the embodiment is that the navigation unit 30 detects the vehicle position and stores the vehicle position information in the hard disk thereof, while associating the vehicle position information with the vehicle information and steering information logged by the controller 10.

Yet another feature of the embodiment is that not only the above vehicle information, steering information and position information but also the image data captured by the in-vehicle camera 41 can be stored in a case where the additional unit 40 and the in-vehicle camera 41 are retro-fitted.

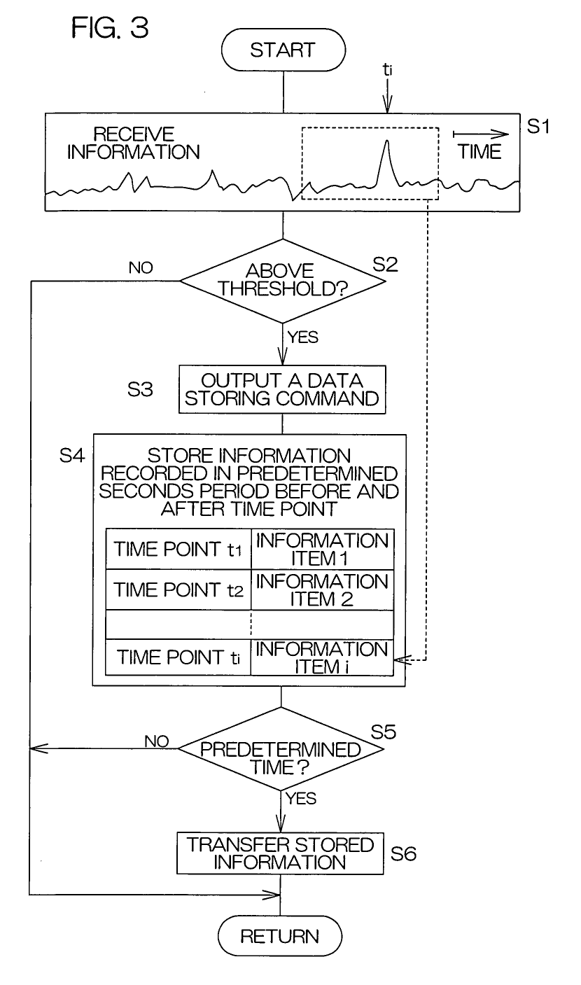

A control operation by the controller 10 shown in FIG. 2 is described as below according to a flow chart shown in FIG. 3.

FIG. 3 is a flow chart showing a control operation executed by the controller 10 and the contents of drive-recorder operations executed by the memory controlling section 23, the threshold judging section 24, the data-transfer timing output section 25 and the memory 22.

The controller 10 is supplied with the vehicle information (vehicle acceleration, yaw rate, vehicle speed and the like) and the steering information (steering angle, steering torque and the like). A variety of information items so supplied are stored in a first memory 221 for receiving information, which is constituted by a buffer memory or the like (Step S1). The first memory 221 is a memory of a type such as FIFO memory, which stores the information pieces in the input order until it is filled and which sequentially deletes the information pieces by causing the information pieces to overflow from the memory region in the chronological order, earliest piece first.

In parallel with the first memory 221 storing the information items, the threshold judging section 24 observes the variations of the vehicle acceleration included in the stored information items. The threshold judging section 24 determines whether the vehicle acceleration exceeds a predetermined threshold or not (Step S2). If the threshold is exceeded, the threshold judging section 24 applies a data storing command to the memory controlling section 23 (Step S3). Receiving the data storing command, the memory controlling section 23 stores information recorded, for example, in a tens-second period before and after a time point tᵢ at which the data storing command is applied thereto (the vehicle acceleration exceeds the predetermined threshold), while associating the information with the time point tᵢ, from the information pieces stored in the first memory 221. Specifically, out of the information pieces temporarily stored in the first memory 221, the information piece recorded in the tens-second period before and after the time point tᵢ (the length of time period is optional and a matter of design) is transferred to the second memory 222 for storing information, which stores the information piece in association with the time point tᵢ (Step S4).

The data storing command outputted in Step S3 is also applied to the navigation unit 30 and the additional unit 40 at the same time, as will be described hereinlater.

The operations of Steps S1 to S4 are continuously carried on, whereby plural data items recorded in the respective time periods before and after the respective time points at which the vehicle acceleration exceeds the predetermined threshold are stored in the second memory 222 in association with the time points. For instance, an information item 1 associated with a time point t1, an information item 2 associated with a time point t2, . . . an information item i associated with a time point tᵢ may be stored.

On the other hand, the data-transfer timing output section 25 determines whether it is a predetermined timing for data transfer or not (Step S5). The predetermined timing means, for example, time when the vehicle is parked with the motor idling, or time occurring at the predetermined time intervals at which the data transfer is smoothly carried out (when the controller 10 has such a low control load as to be able to transfer the data). When the data-transfer timing output section 25 outputs a signal indicating that it is the predetermined timing, the memory controlling section 23 transfers the information stored in the second memory 222 or stored in Step S4 to the hard disk of the navigation unit 30 electrically connected thereto by means of an in-vehicle LAN or the like (Step S6).

When the information items stored in association with the time points are thus accumulated in the second memory 222 for logging which is installed in the controller 10, the accumulated information items are transferred to a larger storage unit (hard disk) of the navigation unit 30. Hence, the memory 22 of the controller 10, particularly the second memory 222, need not have a large capacity. The existing controller (steering ECU) 10 may be used as the drive recorder for favorably recording the information.

According to the embodiment, the threshold judging section 24 triggers the storing operation at the time point tᵢ of a moment when the vehicle acceleration exceeds the predetermined threshold, and the vehicle information including the vehicle acceleration, yaw rate, vehicle speed and the like, and the steering information including the steering angle, steering torque and the like are stored for a tens-second period before and after the time point tᵢ.

In general, the vehicle abruptly changes its behavior, particularly the vehicle acceleration changes quickly, in a case where the vehicle is involved in an accident. Therefore, according to the embodiment, whether the vehicle acceleration exceeds the predetermined threshold or not is used as a trigger criterion for the operation of storing the information. In a case where the driver makes a hard stop, as well, there is naturally a great change of the vehicle acceleration and hence, the operation of storing the information is carried out. That is, all the information items stored in the second memory 222 are not related to the accident. Rather, the most (for example, 90% or more) of the information items may be unrelated to the vehicle accident. However, even though these information items are unrelated to the accident, the changes of the yaw rate, vehicle speed, steering angle, steering torque and the like recorded in the tens-second period before and after the vehicle acceleration exceeding the predetermined threshold may provide useful drive recorder information which may be analyzed to contribute to safe driving.

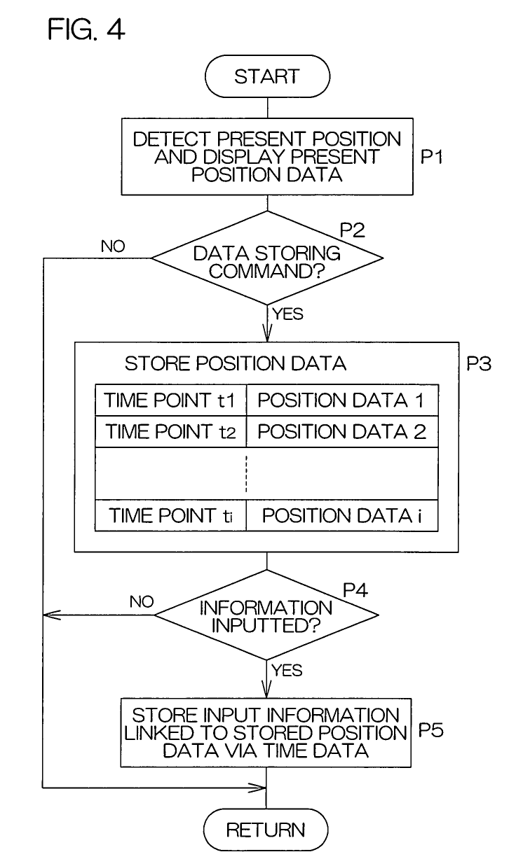

FIG. 4 is a flow chart showing the steps of a control operation performed by the navigation unit 30. As described with reference to FIG. 3, when the data-transfer timing output section 25 determines that it is the predetermined time to transfer the information, the memory controlling section 23 transfers the logged time points and information items from the second memory 222 to the navigation unit 30. Receiving the data thus transferred, the navigation unit 30 performs the control operation shown in FIG. 4.

The navigation unit 30 performs a normal operation to detect the present position of the vehicle based on a GPS signal and the like and displays the present vehicle position data on a map (Step P1).

In parallel with the detection of the present position and the display control operation, the navigation unit 30 determines whether the data storing command is outputted or not (Step P2). As described above, the data storing command is supplied from the threshold judging section 24 of the controller 10. At the moment when the vehicle acceleration exceeds the predetermined threshold, the threshold judging section 24 outputs the data storing command to the memory controlling section 23 and to the navigation unit 30 as well.

In response to the data storing command so supplied, the navigation unit 30 stores the position data recorded at the time point tᵢ of interest in the memory. The position data may be numerical data representing degrees of latitude and longitude or values on coordinate axes, or image data indicating the vehicle position on the map data.

Every time the data storing command is outputted, the position data is stored as associated with the time point at which the data storing command is supplied (Step P3).

Subsequently, when the information is transferred from the controller 10 (the operation of transferring the information is accomplished) (YES in Step P4), the navigation unit 30 links the input information to the time data, thereby associating the input information thus transferred with the position data stored in Step P3 and then storing the resultant data/information at the hard disk or the like (Step P5).

Accordingly, when the vehicle acceleration exceeds the predetermined threshold, the vehicle information items, the steering information items and the vehicle position data recorded in the tens-second period before and after the time point that the vehicle acceleration exceeds the predetermined threshold may be stored in the navigation unit 30 as the drive recorder information.

By the way, the navigation unit 30 is generally installed in the interior of the vehicle at place easy for a user to manipulate, in order to permit the user to insert a disk storing an electronic map or to perform other necessary operations.

On the other hand, the controller (steering ECU) 10 is incorporated in the power steering apparatus and hence, is normally disposed at place un-accessible to the user and hard for the user to manipulate the controller.

Therefore, the constitution is made such that the drive recorder information is transferred to the navigation unit 30 and stored in the hard disk of the navigation unit 30. This constitution offers an advantage that the drive recorder information may be retrieved from the navigation unit 30.

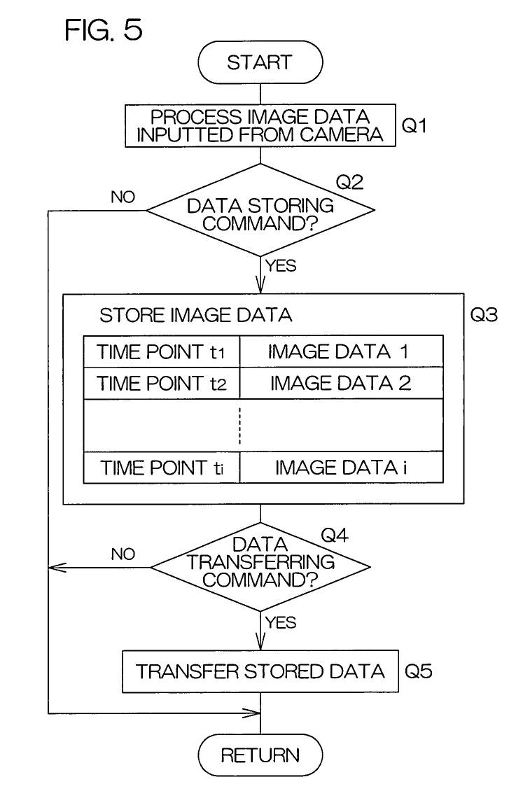

FIG. 5 is a flow chart showing the steps of a control operation performed by the additional unit 40 shown in FIG. 2. The additional unit 40 normally processes the image data supplied from the in-vehicle camera 41 and displays the image data on the display screen or the like as needed (Step Q1).

Receiving the data storing command from the threshold judging section 24 of the controller 10 (YES in Step Q2), the additional unit 40 stores the image data recorded at the moment (time point tᵢ) of receiving the data storing command, while linking the image data to the time point tᵢ (Step Q3).

Specifically, the additional unit 40 sequentially stores the image data pieces recorded at individual moments when the vehicle acceleration exceeds the predetermined threshold.

In a case where the additional unit 40 has a large memory, the additional unit 40 may be adapted to store not only the image data piece recorded at the time point tᵢ, but also the image data pieces recorded in a certain period (tens of seconds) before and after the time point tᵢ.

Receiving the data transferring command (command to transfer the data) (YES in Step Q4), the additional unit 40 transfers the time data and the image data stored therein to the navigation unit 30 (Step Q5).

The data transferring command (command to transfer data) in Step Q4 is applied from the data-transfer timing output section 25, for example. In response to the data transferring command, the additional unit 40 transfers the stored image data to the navigation unit 30, which links the transferred image data to the position data and the inputted information based on the time data and then, stores the resultant data/information.

Thus, the information related to the change of the vehicle acceleration, the change of the vehicle speed, the change of the yaw rate, the change of the steering angle, the change of the steering torque and the like recorded in the tens-second period before and after the moment when the vehicle speed exceeds the predetermined threshold is associated with the vehicle position at the moment of interest and with the image data on outside circumstances captured by the in-vehicle camera at the moment of interest, and the information and data so associated are stored in the navigation unit 30.

Therefore, the information and data stored in the navigation unit 30 can be effectively used as the drive recorder information.

The above embodiment has been described by use of an example where all the information and data are eventually stored in the navigation unit 30. In a case where the additional unit 40 includes a large memory such as a hard disk, however, an alternative constitution may be made such that the information and data are stored in the additional unit 40.

In a case where the memory 22 of the controller 10 has a large capacity, the vehicle information, steering information and vehicle position information may be stored in the memory 22 of the controller 10 rather than in the navigation unit 30.

In the foregoing embodiment, the signal indicative of the vehicle acceleration exceeding the predetermined threshold is used as the trigger signal for storing the information. However, any other signal may be used to trigger the operation of storing the information. For instance, the operation of storing the information may be triggered by a signal indicating that the change of the vehicle speed exceeds a predetermined threshold, that the change of the yaw rate exceeds a predetermined threshold, that the change of the steering angle exceeds a predetermined threshold, that the change of the steering torque exceeds a predetermined threshold, or such.

According to the invention, a low-cost and versatile drive recorder can be constructed by utilizing the existing vehicle electronic control unit such as the steering ECU, and imparting the drive recorder functions to the steering ECU.

While the foregoing embodiments illustrate the example where the steering ECU is utilized as the drive recorder, an engine ECU or the like may be imparted with such functions.

In either case, the constitution is made such that the basic functions of the drive recorder are imparted to the existing vehicle electronic control unit (ECU), from which the information stored therein is eventually transferred to the navigation unit 30 or the additional unit 40, from which the information can be retrieved. The constitution can facilitate the retrieval of the information and can provide the implementation of user-friendly drive recorder functions.

The invention is not limited to the foregoing embodiments, and various changes or modifications may be made thereto within the scope of the appended claims.

The present application corresponds to Patent Application No. 2006-224998 filed with Japanese Patent Office on Aug. 22, 2006, the whole disclosure of which is incorporated herein by reference.

What is claimed is:

1. An in-vehicle controller for use in a vehicle equipped with a navigation unit, comprising:
a storage unit arranged to store vehicle information and steering information in chronological order; and
a writing control unit arranged to write the vehicle information and steering information stored in the storage unit to the navigation unit in a predetermined timing.

2. An in-vehicle controller according to claim 1, wherein the storage unit includes:
a first storage unit arranged to store the inputted vehicle information and steering information in an input order; and
a second storage unit arranged to store some information stored in the first storage unit, which responds to that a predetermined information item of the inputted vehicle information exceeds a predetermined threshold, in a predetermined period before and after the moment of exceeding the threshold with a time point of the moment of exceeding the threshold.

3. An in-vehicle controller according to claim 2, further comprising:
an acquisition unit arranged to acquire vehicle position information detected by the navigation unit; and
a position information writing control unit arranged to write vehicle position information which acquires from the acquisition unit into the storage unit or the navigation unit, the vehicle position information indicates at the moment of exceeding the threshold accompany with the vehicle information and steering information.

4. An in-vehicle controller according to claim 3, further comprising:
a camera unit arranged to get at least an image of outside circumstances of the vehicle; and
an image data writing control unit arranged to write the image data got by the camera unit into the storage unit or the navigation unit, the image data shows the image at the moment of exceeding the threshold accompany with the vehicle information and the steering information.

5. An in-vehicle controller for use in a vehicle equipped with a navigation unit, comprising:
a storage unit arranged to store vehicle information and steering information in chronological order,
the storage unit including
a first storage unit arranged to store the inputted vehicle information and steering information in an input order, and
a second storage unit which responds to that a predetermined information item of the inputted vehicle information exceeds a predetermined threshold, and stores some information stored in the first storage unit in a predetermined period before and after a moment of exceeding the threshold while associating the information with a time point of the moment of exceeding the threshold;
a writing control unit arranged to write the vehicle information and steering information stored in the storage unit to the navigation unit in a predetermined timing;
camera unit arranged to get at least an image of outside circumstances of the vehicle; and
an image data writing control unit arranged to store image data, which is got by the camera unit at the moment of exceeding the threshold, with associated vehicle information and steering information in the storage unit or the navigation unit.
